(19) United States
(12) Patent Application Publication
(10) Pub. No.: US 2013/0076506 A1
(43) Pub. Date: Mar. 28, 2013

(54) System and Method for Testing and Calibrating Audio Detector and Other Sensing and Communications Devices

(71) Applicants: Richard Alan Smith, El Dorado Hills, CA (US); Kevin G. Piel, Ronkonkoma, NY (US); John M. Kovach, Shoreham, NY (US)

(72) Inventors: Richard Alan Smith, El Dorado Hills, CA (US); Kevin G. Piel, Ronkonkoma, NY (US); John M. Kovach, Shoreham, NY (US)

(73) Assignee: Honeywell International Inc., Morristown, NJ (US)

(21) Appl. No.: 13/241,715

(22) Filed: Sep. 23, 2011

(51) Int. Cl. G08B 29/00

(52) U.S. Cl. 340/514

(57) ABSTRACT

A glass break detector can be tested using a smart phone and a downloaded test application. The recommended test procedure can be implemented by interacting with the phone and the executing application. The phone can emit a selected audio test signal to which the detector can respond. Advantageously, the installer does not need to read a test procedure from a manual and does not need to use a special test tool.

### FIELD

The application pertains to glass break detectors and installation of such detectors. More particularly, it pertains to systems and methods to test installed glass break detectors.

### BACKGROUND

Audio detection devices, such as glassbreak detectors, should be properly tested for range and sensitivity in the application environment; otherwise the detector may not be optimized, resulting in the likelihood of problems with false alarms and/or detection. These devices typically include specific installation recommendations and/or requirements that define what steps the installer should perform to validate that the installation will result in optimal performance. (i.e. range and sensitivity). Previously, the installation range and sensitivity verification procedure required the use of a specific audio test device.

For example, in the case of glassbreak detectors a glassbreak simulator would be used. Such simulators generate a calibrated audio signal. This requires the installer to have such test device on hand at the time of installation. Although some installers may have the recommended range test device in their work vehicle, it is not often used since it is not very convenient. This results in many installations of audio detection devices not being properly verified or optimized.

### BRIEF DESCRIPTION OF THE DRAWINGS

FIG. 1 is an overall diagram illustrating aspects of a system in accordance herewith;

FIG. 2 is a block diagram illustrating aspects of an exemplary glass break detector; and

FIG. 3 is a flow diagram illustrating aspects of a detector which is responsive to specific methods of testing.

### DETAILED DESCRIPTION

While disclosed embodiments can take many different forms, specific embodiments thereof are shown in the drawings and will be described herein in detail with the understanding that the present disclosure is to be considered as an exemplification of the principles thereof as well as the best mode of practicing same, and is not intended to limit the application or claims to the specific embodiment illustrated.

Audio detection devices, such as glassbreak detectors, should be properly tested and calibrated for range and sensitivity in the application environment; otherwise the detector may not be optimized, resulting in the likelihood, of problems with false alarms and/or detection. These devices typically include specific installation recommendations and/or requirements that define what steps the installer should perform to validate that the installation will result in optimal performance. (i.e. range and sensitivity).

In embodiments hereof, the installer of an audio detector would be provided an option to download an application A1 to a portable communications device P, and then perform the recommended test procedure, which would be included within the application A1, eliminating the need to read a procedure to perform the test. This also prevents the installer from needing to purchase/carry/bring the detector manufacturer's recommended range test tool. The device P could be implemented as a smart phone, a cell-type phone, a wireless pad-type communications device, or other equivalent communications device, all without limitation.

The application A1 when executed on the device P “talks” the installer I through the installation steps, making the installation test as simple as practical. The following process is applicable to a glassbreak detector, but is not limited to such detectors. Device P includes a speaker, for audio output Pa, a keyboard, or the like, Pb for data or information input to the phone P, and, a display Pc. It will be understood that the details of any particular smart phone-type product are not limitations of the present disclosure. A variety of smart phones, or other communications devices will come within the spirit and scope hereof.

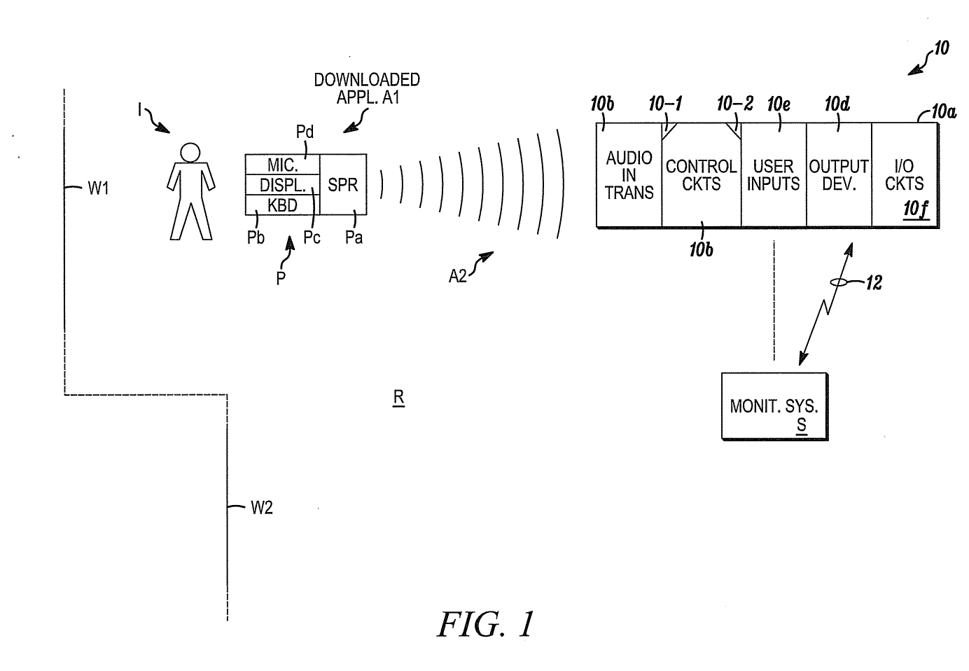

FIG. 1 is a diagram of a region R which is being monitored, and which has two windows, W1, W2. Window W1 is furthest away from a glass break detector 10 which is intended to monitor the condition of windows W1, W2. The detector 10 communicates with a security monitoring system S via a medium 12 which could be wired or wireless. The detector 10 could be one of a plurality of security, or ambient condition detectors coupled to the system S, all without limitation.

A representative-type detector 10 can include a housing 10a which carries a plurality of major components. These included, without limitation, at least one audio input transducer 10b, control circuits 10c, various output devices 10d, and user inputs 10e.

The control circuits could include a programmable processor 10-1 and associated, pre-stored, executable, control software 10-2. Input/output circuits 10f, coupled to control circuits 10c communicate via medium 12 with the system S.

While the exemplary detector 10 is illustrated and described as a glass break detector, the present interactive process is not limited to such detectors. The present process could alternately be used to test operation and/or installation of other types of detectors without limitation. For example, door position detectors, PIR-type detectors, ambient condition detectors including gas detectors, and smoke detectors could all be installed and evaluated in accordance with an interactive process of the type described herein.

The downloaded application A1 will instruct the installer I to point the device's speaker Pa at the detector 10, and within a specified distance. The installer I will confirm that he/she is within the specified distance, via the keyboard Pb, for example. The device's application A1 will then output an audio signal A2 which the detector 10 is designed recognize as an “enter test mode” signal.

The application A1 will ask the installer Ito confirm that the device 10 is in test mode, and then will instruct the installer I to move near the window farthest from the detector, such as window W1, for a glassbreak detector. The installer I is then asked to confirm the step and then strike the window W1 with a soft cushioned tool or soft side of a fisted hand. The application A1 is programmed to recognize the flexing of the glass using a microphone Pd., in this case within the device P.

Upon proper confirmation the application A1 will then output an audio test signal which the detector 10 responds to. The application A1 will ask the installer I via speaker Pa, if the detector 10 confirmed that detected signal was of the proper level. If not, the installer I would be instructed to adjust the detector's sensitivity accordingly in the case of a manually adjustable detector. Alternately, the detector could self adjust.

The detector 10 would provide confirmation of the step by indicating the results on its local indicators (i.e. LEDs) 10d. Following the manual adjustment step, if needed, the installer I could repeat the verification steps from the beginning. In the case of the self adjusting detector the steps would not have to be repeated, if the detector confirmed that it properly detected the range test signal.

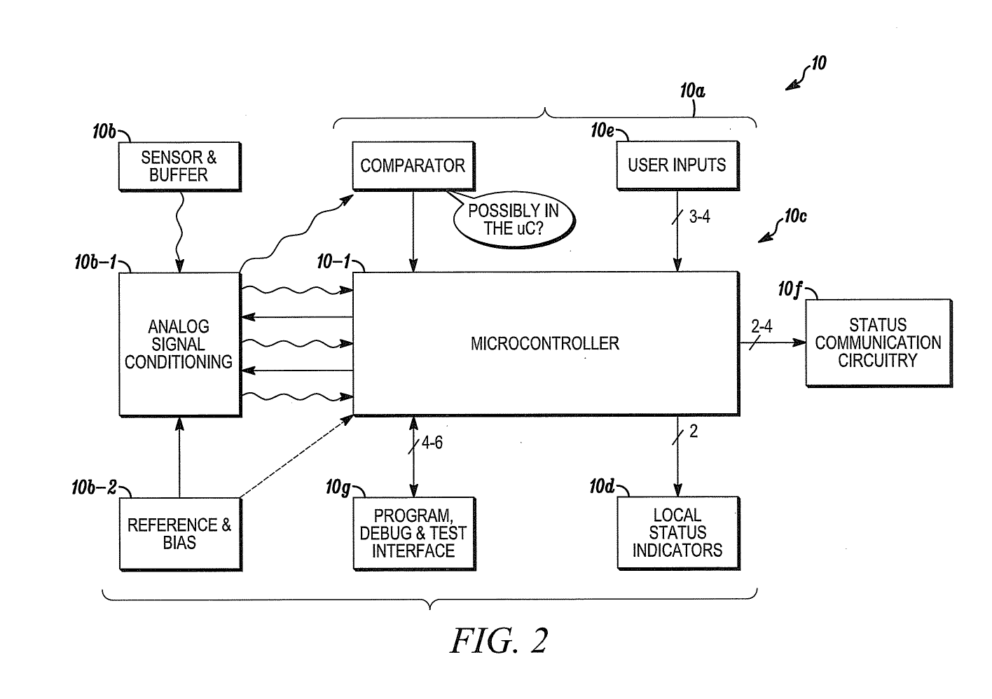

FIG. 2 illustrates additional aspects of the detector 10. Analog signal conditioning circuitry 10b-1, -2 could also be carried by housing 10. A program debug and test interface 10g could also be coupled to the processor 10-1.

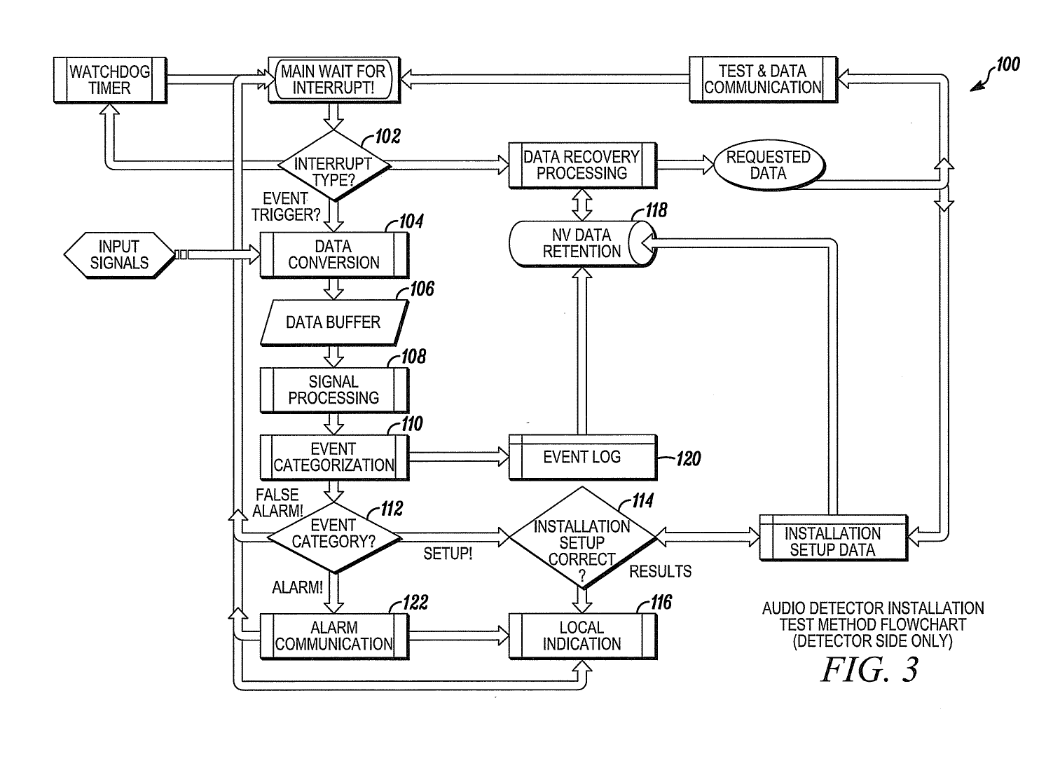

FIG. 3 illustrates aspects of a method 100 which includes responding to and determining an interrupt type, as at 102. If an event trigger has been detected, data/signal processing can be carried out, as at 104-108, of received input signals, for example, audio A2 discussed above.

Events can be categorized, as at 112. Where a setup event is recognized, installation results can be evaluated as at 114. Outputs indicative of the installation evaluation process can be indicated locally as at 116. Installation setup data can be stored as at 118. Events can be logged as at 120. Where the event corresponds to an alarm, an alarm communication can be issued as at 122.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims. Further, logic flows depicted in the figures do not require the particular order shown, or sequential order, to achieve desirable results. Other steps may be provided, or steps may be eliminated, from the described flows, and other components may be added to, or removed from the described embodiments.

1. An apparatus comprising:
a portable communications device which includes executable software stored therein,
circuitry to emit a test mode entry audio output; and
circuitry to subsequently emit a selected glass break detector test signal.

2. An apparatus as in claim 1 where the device emits initial test location specifying instructions.

3. An apparatus as in claim 1 where the device includes circuits to respond to a test location confirmation input.

4. An apparatus as in claim 1 where the device emits audible instructions to carry out a detector test.

5. An apparatus as in claim 4 where the device includes circuitry to provide audio instructions seeking confirmation of test results.

6. An apparatus as in claim 5 where the device, responsive to test results, outputs detector adjustment instructions.

7. An apparatus as in claim 5 which includes a glassbreak detector, and the device comprises one of a cell-type phone, or a pad type communications device.

8. An apparatus as in claim 7 where the detector includes test mode circuits.

9. An apparatus as in claim 7 where the detector includes at least one output device and circuits to indicate test results.

10. An apparatus as in claim 7 where the detector includes at least one of a manually adjustable input element, or automatic adjustment circuits.

11. A glassbreak detector comprising:
a glassbreak sensor; and
control circuits coupled to the sensor, where the control circuits respond to a received test mode initiating signal.

12. A detector as in claim 11 which includes other circuits responsive to an audio test signal, to output a test configuration indicator.

13. A detector as in claim 12 which includes at least one of a manually adjustable input element, or automatic adjustment circuits.

14. A method comprising:
providing a multi-mode communications device, where at least one mode implements voice communications;
generating an audible enter test mode indicator, and responsive thereto, entering a test state;
confirming that the test state has been entered;
generating an audible test signal; and
confirming that the test signal was at or above a predetermined level at a received location, and, responsive thereto, if not, making needed adjustments.

15. A method as in claim 14 which includes determining that the communications device is a predetermined distance from a detector being tested.

16. A method as in claim 15 wherein the detector enters the test state responsive to receiving the generated audible indicator.

17. A method as in claim 16 which includes striking a selected window, receiving feedback from the window, and in the presence of a selected feedback signal, generating the audible test signal.

18. A method as in claim 17 which includes downloading a selected software application to the communications device to implement a test process.

19. An apparatus comprising:
a cell-type phone which includes downloadable;
executable software stored therein including circuitry to emit a selected test mode output; and
circuitry to subsequently emit a selected detector test signal.

20. An apparatus as in claim 19 where the detector to be tested is selected from a class which includes at least, glass break detectors, position detectors, passive infrared detectors, motion detectors, ambient condition detectors including smoke detectors, gas detectors, humidity detectors, and thermal detectors.
